(19) United States
(12) Patent Application Publication
(10) Pub. No.: US 2004/0245735 A1
(43) Pub. Date: Dec. 9, 2004

(54) Garbage can transport apparatus

(76) Inventor: Arthur Pins, Frisco, CO (US)

Correspondence Address: STURM & FIX LLP, 206 SIXTH AVENUE, SUITE 1213, DES MOINES, IA, 50309-4076, US

(21) Appl. No.: 10/454,035

(22) Filed: Jun. 4, 2003

(51) Int. Cl. B62B 1/00

(52) U.S. Cl. 280/79.5

(57) ABSTRACT

A wheeled transport apparatus (10) for the storage and transport of a garbage can (100) wherein, the apparatus (10) includes a weighted base element (21) having a rearward portion provided with a handle element (24) and a wheel assembly (23) and further including a pair of arcuate capture arms (42) (43) slidably received in a hollow arcuate housing element (41) that is fixedly secured to the top surface (25) of the base element (21) whereby, the housing element (41) and the capture arms (42) (43) are adapted to completely surround the periphery of a garbage can (100) during transport from one location to another location.

### CROSS REFERENCE TO RELATED APPLICATIONS

The present invention was the subject matter of Document Disclosure Program Registration No. 513,115, filed in the U.S. Patent and Trademark Office on Jun. 14, 2002.

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

1. Field of the Invention

The present invention relates to the field of garbage can transport devices in general and in particular to a garbage can transport apparatus having releasably engageable capture arms that are adapted to temporarily surround the garbage can during transport.

2. Description of Related Art

As can be seen by reference to the following U.S. Pat. Nos. 4,905,945; 3,990,654; 4,666,054; and, 5,897,018, the prior art is replete with myriad and diverse garbage can transport devices.

While all of the aforementioned prior art constructions are more than adequate for the basic purpose and function for which they have been specifically designed, they are uniformly deficient with respect to their failure to provide a simple, efficient, and practical arrangement for storing and transporting a garbage can in a safe, secure and stable fashion with a minimum of fuss and bother.

Unfortunately, the prior art seems to be concerned exclusively with either stability or ease of transport and they have failed to develop a single arrangement that gives equal weight to both of these desirable characteristics.

As a consequence of the foregoing situation, there has existed a longstanding need for a new and improved garbage can transport apparatus that is extremely stable and easy to move from one location to another, as well as, providing a means for adjustably surrounding a selected portion of the garbage can, and the provision of such a construction is a stated objective of the present invention.

### BRIEF SUMMARY OF THE INVENTION

Briefly stated, the garbage can transport apparatus that forms the basis of the present invention comprises in general a transport unit and a capture unit adapted to releasably and selectively surround a garbage can.

As will be explained in greater detail further on in the specification, the transport unit comprises a transport member including a weighted base element having a rear portion provided with a wheel assembly and a handle element wherein, the top surface of the base element may optionally be provided with a generally circular groove.

In addition, the capture unit comprises a capture member including an arcuate generally semi-circular hollow housing element which is dimensioned to slidably receive a pair of elongated arcuate capture arms which cooperate with the housing element to completely surround the intermediate and lower periphery of a garbage can.

In addition, the generally circular groove in the base element is partially disposed within the arcuate housing element and dimensioned to slidably receive the lower portion of each of the arcuate capture arms.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the garbage can transport apparatus that forms the basis of the present invention;

FIG. 2 is a top plan view of the transport apparatus;

FIG. 3 is a side elevation view of the apparatus with the capture arms in their retracted position; and,

FIG. 4 is a side elevation view of the apparatus with the capture arms in their extended position.

### DETAILED DESCRIPTION OF THE INVENTION

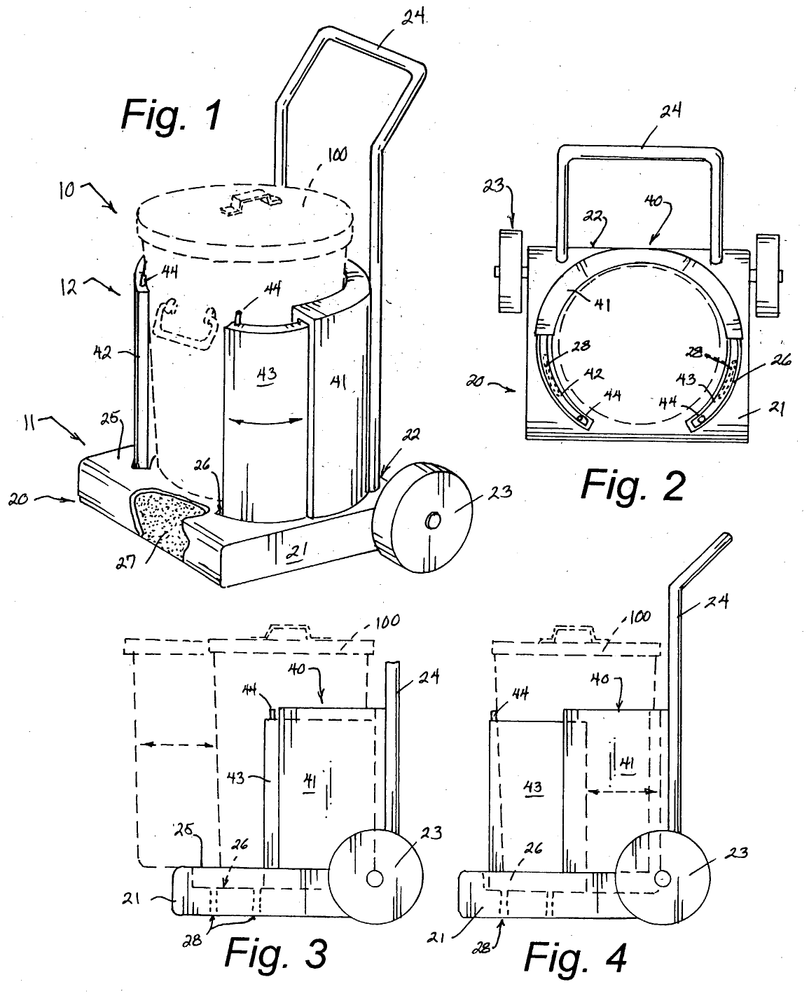

As can be seen by reference to the drawings, and in particularly to FIG. 1, the garbage can transport apparatus that forms the basis of the present invention is designated generally by the reference number 10. The apparatus 10 comprises in general a transport unit 11 and a capture unit 12. These units will now be described in seriatim fashion.

As shown in FIGS. 1 through 4, the transport unit 11 comprises a wheeled transport member 20 that includes a weighted base element 21 having a proximal end 22 provided with both a wheel assembly 23 and an upwardly projecting generally inverted U-shaped handle element 24 the height from the top surface 25 of the base element 21 of which is greater than the height of a conventional garbage can 100.

In addition, the top surface 25 of the base element 21 is further provided with a generally circular groove 26 provided with a plurality of drainage apertures 28 and the interior portion of the base element 21 is provided with a quantity of material 27 such as sand, water, etc., that adds stabilizing weight to the base element.

As can also be seen by reference to FIGS. 1 through 4, the capture unit 12 comprises a capture member 40 that includes a semi-circular raised hollow arcuate housing element 41 that projects upwardly from the top surface 25 of the base element 21 and covers approximately half of the generally circular groove 26 formed therein.

In addition, in the preferred embodiment of the invention depicted in FIGS. 1 through 4, the capture member 40 further includes a pair of arcuate capture arms 42 43 that are dimensioned to be slidably received within the arcuate housing element 41 and the groove 26 in the top surface 25 of the base element 21 wherein, the capture arms 42 43 and the arcuate housing element 41 are dimensioned to completely surround the periphery of a garbage can 100.

At this juncture, it should be noted that this invention also contemplates the use of a single radial capture arm 42 having a generally semi-circular configuration which, when used in conjunction with the semi-circular radial housing element 41 would also completely encircle the periphery of a garbage can 100 in a well recognized manner.

Turning now specifically to FIGS. 1 through 3, it can be seen that in the preferred embodiment of the invention, the outboard ends of the capture arms 42 43 are further provided with upwardly extending posts 44 that prevent the capture arms from being completely retracted within the housing element 41 wherein, each of the capture arms 42 43 defines an arc of approximately 90°.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A garbage can transport apparatus for storing and transporting a garbage can wherein, the apparatus comprises
a transport unit comprising a wheeled transport member including a base element having a top surface and further provided with a wheel assembly and an upwardly extending handle element operatively associated with said base element; and,
a capture unit including a hollow radial housing element projecting upwardly from the top surface of the base element and defining an arc of approximately 180° and at least one radial capture arm slidably received in said radial housing element.

2. The apparatus as in claim 1; wherein, said at least one radial capture arm has a minimum arc of approximately 90°.

3. The apparatus as in claim 1; wherein, said at least one radial capture arm has a maximum arc of approximately 180°.

4. The apparatus as in claim 1; wherein, the capture unit includes a pair of capture arms slidably received in the opposite ends of the hollow housing element.

5. The apparatus as in claim 4; wherein, at least one of the pair of capture arms defines an arc of approximately 90°.

6. The apparatus as in claim 4; wherein, said pair of capture arms combine to define an arc of approximately 180°.

7. The apparatus as in claim 4; wherein, the top surface of the base element is provided with a generally circular groove dimensioned to receive a portion of said pair of capture arms.

8. The apparatus as in claim 1; wherein, the top surface of the base element is provided with a generally circular groove dimensioned to receive said at least one capture arm.

9. The apparatus as in claim 1; wherein, the base element has a hollow interior.

10. The apparatus as in claim 1; wherein, the base element has an interior that is at least partially filled with a quantity of weighted material.

11. The apparatus as in claim 8; wherein, said generally circular groove is provided with a plurality of drainage apertures.
